(19) United States
(12) Patent Application Publication
(10) Pub. No.: US 2017/0334571 A1
(43) Pub. Date: Nov. 23, 2017

(54) ANTI-BIRD STRIKE PROTECTION NET FOR AIRCRAFT JET ENGINE

(71) Applicant: DEPEI BAI, Auckland (NZ)

(72) Inventor: DEPEI BAI, Auckland (NZ)

(21) Appl. No.: 15/159,805

(22) Filed: May 20, 2016

(51) Int. Cl. B64D 33/02; F01D 25/24; F02C 7/055; F01D 25/10

(52) U.S. Cl. CPC B64D 33/02; F01D 25/10; F01D 25/24; F02C 7/055; F05D 2250/12; B64D 2033/022; F05D 2220/323; F05D 2250/141; F05D 2250/232; F05D 2300/171; F05D 2250/11

(57) ABSTRACT

An anti-bird strike protection net for aircraft jet engine, comprising fixed circular truncated cone, conical protection net body, connection section, and double helix electrical heating wire, wherein the fixed circular truncated cone is secured on the cowl inlet's outside of the aircraft jet engine via which the conical protection net body is connected to the jet engine with the connection section: hinge, catches, and gas springs; The conical protection net body comprises the base of the conical protection net body, the conical support frame, the net which covers the outside of the conical support frame; the double helix electrical heating wire spirally surrounding the surface of the net is used as deicing device.

This invention is an aftermarket add-on device and can be an original integration part as jet engine manufacturing. It's simple and easy to be secured on the cowl inlet without changing the structure of the aircraft jet engine.

### INVENTION BACKGROUND

The aviation industry has been puzzled for years by the issues of the collisions of flying birds with aircraft jet engines, the collisions of flying birds with aircraft jet engines may happen in both air and runway, but it's much more unpredictable and uncontrollable for the collisions happening in the air. Flying birds may collide with the leading edges of the aircraft, such as wings, fuselages, radomes, cowl inlets of aircraft jet engines, which will damage the jet aircraft, in case the flying birds strike the jet engines or being sucked into, the engine blades will be destroyed so as to destroy the whole engines, and there would be catastrophic consequences.

Almost all birds from barn swallow, horned lark to red-tailed hawk, Canada goose may be potential harmful to jet engines, especially Canada goose, many American airports have to take zero tolerance policy to it!

On Jan. 15, 2009, Airbus A320-214, US Airways Flight 1549 was struck by Canada geese shortly after taking off from La Guardia Airport, the bird strike resulted in immediate and complete thrust loss to both engines, the screw ditched the plane to the Hudson River and 151 people on board were rescued.

In June 2010, A Royal Air Maroc Boeing 737-400 with 162 people on board, struck a flock of geese after departing Amsterdam's Schiphol Airport, three engine blades fractured at about mid-span and damaged to all the rest of the engine blades and damaged to the left engine's low-and-high pressure compressors and the combustion chamber etc.

High lighting the global nature of the risk, the European Space Agency has reported the worldwide aircraft-bird collisions costed airlines more than $1.2 billion a year.

With air travel is getting more and more popular, the jet engine's power is getting more and more powerful and quiet, surrounding's innovation makes birds quantity getting more and more, all those factors contribute to more and more bird strike opportunities!

People have tried many methods to solve this problem, on ground: sound, flash, electrical, and their combination methods have been taken, artificial figures horrifying, birds trapping, shooting, destroying birds' surviving environment, radar detection and spraying bird repellents and other professional methods have been taken as well.

when the aircraft taking off the ground, the situation will become more complicated: the aircraft are large, the night vision is not so good, and the flying birds may appear by randomly.

American patent publication US2014/0145035A1 (Pub. Date May 29, 2014) describes an aircraft carries an apparatus for discharging a persistent vapor of bird repellents into an elevated airspace, but the huge airspace and wind blowing will decrease the efficiency, the bird repellents will pollute the environment nearby.

Another U.S. Pat. No. 6,536,202B2 (Date of Patent: Mar. 25, 2003) describes an air net device is located adjacent to the cowl inlet so as to create an air net by compressed air streams for blowing foreign objects from entering the cowl inlet of jet engine, we can imagine that the air net is so powerful to prevent foreign objects from entering the cowl inlet of jet engine, that will definitely affect the incoming air amount which the jet engine needs to produce the normal thrust as well, the heavy add-on device which is secured on the cowl inlet of the jet engine will certainly change the aerodynamic characteristics of the jet engine.

China utility model patent CN2837202Y describes a protection cover is secured on the cowl inlet of the jet engine, but it hasn't given the details about how to prevent the bird strike and how to check and do the routine maintenance to the jet engine.

### SUMMARY OF THE INVENTION

A main object of the invention is to provide an anti-bird strike protection net for aircraft jet engine.

Another object of the invention is to provide an anti-bird strike protection net for aircraft jet engine comprising fixed circular truncated cone, conical protection net body, connection section, and double helix electrical heating wire.

Among them, the fixed circular cone is made of stainless steel or other alloys, its inner size and shape is the same with the outside size and shape of the cowl inlet of the jet engine, and it's secured on the outside of the cowl inlet of the aircraft jet engine by welding, riveting, gluing, and any combination of those methods.

The conical protection net body comprises the circular truncated cone as the base of the conical protection net body, the conical support frame, the net which covers the outside of the conical support frame.

The conical support frame comprises the lateral support bars, the level support bars, the vertical support rings, and two handles, one ends of the lateral support bars are welded on the summit of the conical support frame, another ends are evenly welded on the parameter of the base of the conical protection net body, two of the lateral support bars are in the same horizontal level with the axial of the conical support frame and are defined as level support bars, the handles and one ends of the gas springs are secured on the level support bars.

The vertical support rings are vertical to the axial of the conical support frame and connected with the lateral support bars and the level support bars by welding.

In outside of the conical support frame, there is a layer of net made of metals, alloys, or synthetic materials, they can be different shapes and sizes to meet the demands for protecting birds from entering aircraft jet engines.

The other object of the invention is to provide the connection section comprising hinge, catches, and gas springs.

When the fixed circular truncated cone and the base of the conical protection net body are closed together, they make a common parameter on which the hinge is on the highest position and the catches are welded along it. Two plates of the hinge are separately welded on those two circular truncated cones, the catch includes two parts: hook seat and suspension link, the hook seats are welded on the base of the conical protection net body and the suspension links on the fixed circular truncated cone. One end of the gas spring is secured on the fixed circular truncated cone and another end on the middle part of the level support bar; the handle is welded on the middle part of the level support bar as well.

Another object of the invention is to provide a double helix electrical heating wire as a deicing device which is covered by an insulating layer and spirally surrounds the surface of the net to the summit of the conical support frame, it's a closed loop circuit, the power is supplied by the power generator on the aircraft, it commences near the hinge and ends near the summit of the conical support frame, the control switches are set in the cab and controlled by the pilots, the pilots decide to switch on/off according to the weather conditions.

Another object of the invention is to provide a series of cone shapes for the conical protection net body, they can be any one of the following shapes: the cone, the truncated elliptical cone+the cone, the elliptical cone, the truncated cone+the cone, the truncated cone+the elliptical cone.

Meanwhile, to align with different cowl inlet shapes of jet engines of military or other purpose aircraft, the cowl inlet shapes of the jet engines may vary from round to ellipse, semi-circle, and rectangle.

The further object of the invention is to provide an anti-bird strike protection net for aircraft jet engine, which is an aftermarket add-on device and can be an original integration part as jet engine manufacturing.

The process for the service people to do the routine maintenance or check is as followings: open the catches, hold the handles with hands or other lifting machines and push the conical protection net body upwards, with the hinge as turning pivot, to a designed position, the gas springs will hold the conical protection net body and keep it steady, after work done, by reverse operation, lock the catches, the jet engine will be protected by the anti-bird strike protection net.

### BRIEF DESCRIPTION OF THE DRAWINGS

FIG. 1 is the top view of the anti-bird strike protection net for aircraft jet engine(the double helix electrical heating wire is not shown);

FIG. 2 is A-A direction view on FIG. 1;

FIG. 3 is the conical protection net body;

FIG. 4 is the conical support frame;

FIG. 5 is B-B direction view on FIG. 4;

FIG. 6 is the schematic drawing of the double helix electrical heating wire(the net is not shown);

FIG. 7 is the schematic drawing of the anti-birds strike protection net for aircraft jet engine is being opened(the double helix electrical heating wire and the net are not shown);

FIG. 8a is the cone(the present invention);

FIG. 8b is the combination of the truncated elliptical cone and the cone;

FIG. 8c is the elliptical cone;

FIG. 8d is the combination of the truncated cone and the cone;

FIG. 8e is the combination of the truncated cone and the elliptical cone.

In the drawings, the reference numbers are as followings:

1. jet engine;

2. cowl inlet;

3. fixed circular truncated cone;

4. base of the conical protection net body;

5. hinge;

6. catch;

7. vertical support ring;

8. lateral support bar;

9. net;

10. gas spring;

11. handle;

12. level support bar;

13. summit of the conical support frame

14. double helix electrical heating wire.

### DETAILED DESCRIPTION OF THE INVENTION

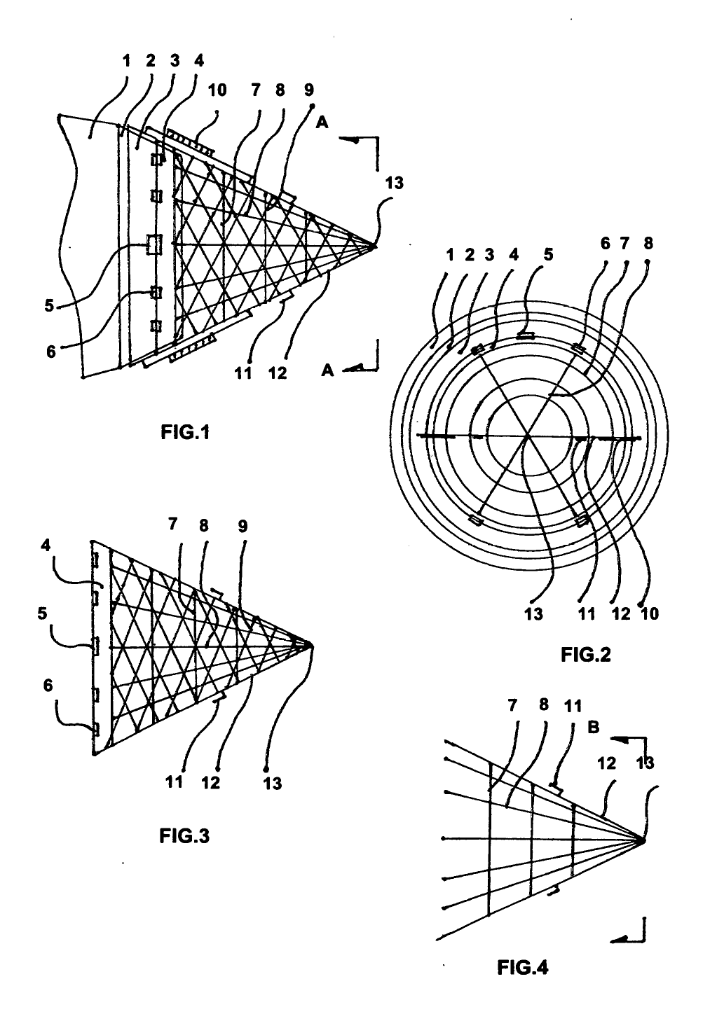

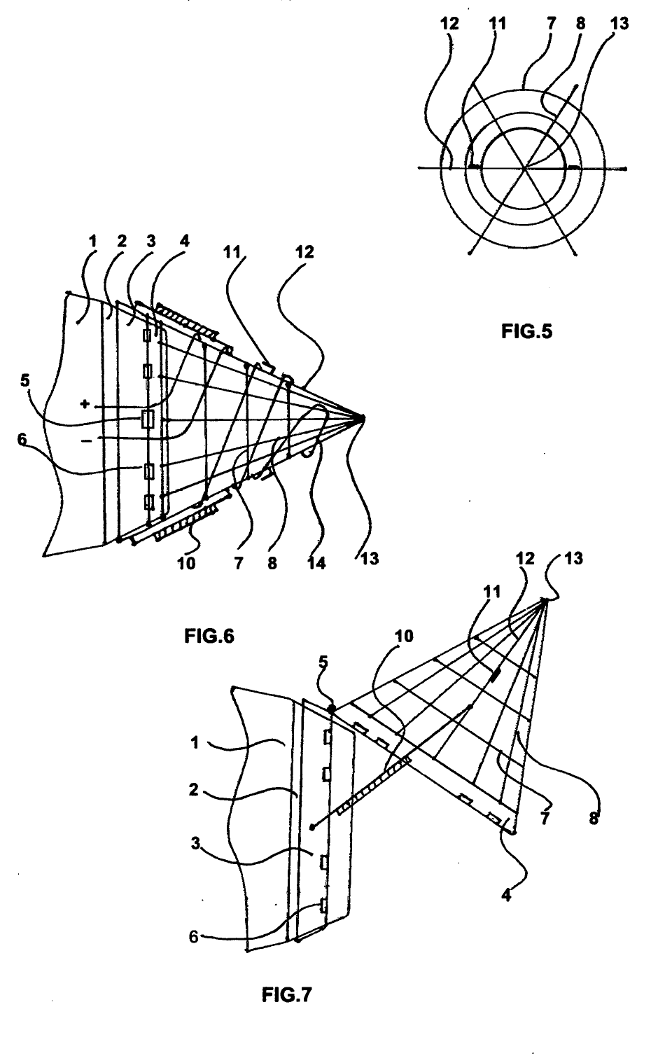

Referring to FIG. 1, FIG. 2, FIG. 3, FIG. 6, the present invention, anti-bird strike protection net for aircraft jet engine comprises the fixed circular truncated cone 3, the conical protection net body, the connection section, and the double helix electrical heating wire 14.

The fixed circular truncated cone 3 is made of stainless steel or other alloys, its inner diameter and shape is the same with the outside diameter and shape of the cowl inlet 2 of aircraft jet engine 1, and it's secured on the outside of the cowl inlet 2 of the aircraft jet engine 1 by welding, riveting, gluing, and any combination of those methods.

Referring to FIG. 3, the conical protection net body comprises the circular truncated cone as the base of the conical protection net body 4, the conical support frame, the net 9 which covers the outside of the conical support frame.

Referring to FIG. 4, FIG. 5, the conical support frame comprises the lateral support bars 8, the level support bars 12, the vertical support rings 7, and two handles 11.

One ends of the lateral support bars 8 are welded on the summit of the conical support frame 13, another ends are evenly welded on the parameter of the base of the conical protection net body 4, two of the lateral support bars 8 are in the same horizontal level with the axial of the conical support frame and are defined as level support bars 12, on the level support bars 12, the handles 11 and one ends of the gas springs 10 are secured; the vertical rings 7 are vertical to the axial of the conical support frame and connected with the lateral support bars 8 and the level support bars 12 by welding.

The total quantity of the lateral support bars 8 are no less than 3; the level support bars 12 are 2; the vertical support rings 7 are no less than 2; the handles 11 are 2.

Referring to FIG. 1, FIG. 3, in outside of the conical support frame, there is a layer of net 9, it's secured on the outside of the conical support frame by welding or gluing, it may be made of stainless steel, other metals, alloys and synthetic materials, sheets of those materials are processed to be expanded metal net 9 by punching and stretching, or the wires of those materials are woven to be net 9, the net mesh may be in shape of triangle, diamond, round, rectangle.

The size of net mesh should be small enough for preventing birds from entering the cowl inlet 2 of the jet engine 1, and meanwhile it has to meet the air demand for the jet engine's normal performance.

Referring to FIG. 1, FIG. 2, the fixed circular truncated cone 3 and the base of the protection net body 4 are circular truncated cones, they are truncated from the same cone, that means the smaller end's diameter and shape of the fixed circular truncated cone 3 is the same with the bigger end's diameter and shape of the base of the protection net body 4.

Referring to FIG. 1, FIG. 2, FIG. 3, FIG. 6, FIG. 7, the connection section comprises the hinge 5, the catches 6, and the gas spring 10, when the fixed circular cone 3 and the base of the conical protection net body 4 are closed together, they make a common parameter on which the hinge 5 is on the highest position and the catches 6 are welded along it. Two plates of the hinge 5 are separately welded on those two circular truncated cones, the catch 6 includes two parts: hook seat and suspension link, the hook seats are welded on the base of the conical protection net body 4 and the suspension links on the fixed circular cone 3.One end of the gas spring 10 is secured on the fixed circular truncated cone 3 and another end on the middle part of the level support bar 12.

The quantity of the gas spring 10 are 2, the catches 6 are no less than 2. Referring to FIG. 6, the double helix electrical heating wire 14 is used as a deicing device which is covered by an insulating layer and spirally surrounds the surface of the net 9 to the summit of the conical support frame 13, it's a closed loop circuit, the power is supplied by the power generator on the aircraft, it commences near the hinge 5 and ends near the summit of the conical support frame 13, the control switches are set in the cab and controlled by the pilots, the pilots decide to switch on/off according to the weather conditions.

Referring to FIG. 7, the process for the service people to do the routine maintenance or check is as followings: open the catches 6, hold the handles 11 with hands or other lifting machines and push the conical protection net body upwards, with the hinge 5 as turning pivot, to a designed position, the gas spring 10 will hold the conical protection net body and keep it steady, after work done, by reverse operation, lock the catches 6, the cowl inlet 2 of the jet engine 1 will be protected by the anti-bird strike protection net for aircraft jet engine.

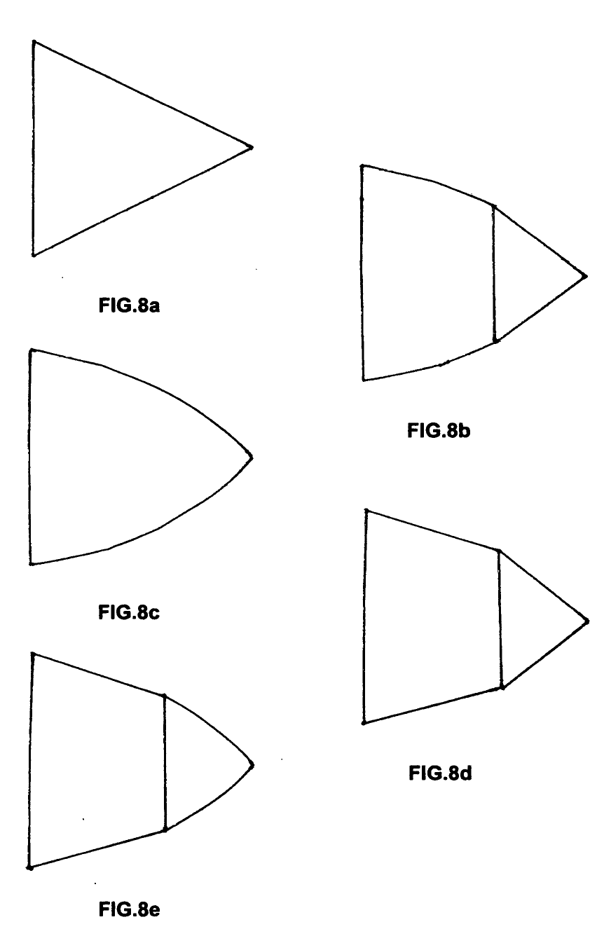

Referring to FIG. 8a to FIG. 8e, in the present invention, the shape of the conical protection net body is cone, the conical protection net body may be in shape of the combination of the truncated elliptical cone and the cone; the elliptical cone; the combination of the truncated cone and the cone; the combination of the truncated cone and the elliptical cone.

What I claim:

1. An anti-bird strike protection net for aircraft jet engine, secured on the cowl inlet 2 of the aircraft jet engine 1, comprises the fixed circular truncated cone 3, the conical protection net body, the connection section, and the double helix electrical heating wire 14.

2. An anti-bird strike protection net for aircraft jet engine as described in claim 1, wherein: The fixed circular truncated cone 3 is made of stainless steel or other alloys, its inner diameter and shape is the same with the outside diameter and shape of the cowl inlet 2 of aircraft jet engine 1, and it's secured on the outside of the cowl inlet 2 of the aircraft jet engine 1 by welding, riveting, gluing, and any combination of those methods.

3. An anti-bird strike protection net for aircraft jet engine as described in claim 1, wherein: The conical protection net body comprises the base of the conical protection net body 4, the conical support frame, the net 9 which covers the outside of the conical support frame.

4. An anti-bird strike protection net for aircraft jet engine as described in claim 3, wherein: The conical support frame comprises the lateral support bars 8, the level support bars 12, the vertical support rings 7, and the handles 11, one ends of the lateral support bars 8 and the level support bars 12 are welded on the summit of the conical support frame 13, another ends are evenly welded on the parameter of the base of the conical protection net body 4; the vertical rings 7 are connected with the lateral support bars 8 and the level support bars 12 by welding; the handles and one ends of the gas springs are secured on level support bars 12.
The total quantity of the lateral support bars 8 are no less than 3; the level support bars 12 are two; the vertical support rings 7 are no less than 2; the handles 11 are 2.

5. An anti-bird strike protection net for aircraft jet engine as described in claim 3, wherein:
the net 9 may be made of stainless steel, other metals, alloys and synthetic materials, sheets of those materials are processed to be expanded metal net 9 by punching and stretching, or the wires of those materials are woven to be net 9, the net mesh may be in shape of triangle, diamond, round, rectangle.

6. An anti-bird strike protection net for aircraft jet engine as described in claim 3, wherein: The fixed circular truncated cone 3 and the base of the protection net body 4 are all circular truncated cones, the smaller end's diameter and shape of the fixed circular truncated cone 3 is the same with the bigger end's diameter and shape of the base of the protection net body 4.

7. An anti-bird strike protection net for aircraft jet engine as described in claim 1, wherein: The connection section comprises the hinge 5, the catches 6, and the gas spring 10, when the fixed circular cone 3 and the base of the conical protection net body 4 are closed together, they make a common parameter on which the hinge 5 is on the highest position and the catches 6 are welded along it. Two plates of the hinge 5 are separately welded on those two circular truncated cones, the hook seats of the catch 6 are welded on the base of the conical protection net body 4 and the suspension links on the fixed circular cone 3. One end of the gas spring 10 is secured on the fixed circular truncated cone 3 and another end on the middle part of the level support bar 12; the quantity of the gas spring 10 are 2, the catches 6 are no less than 2.

8. An anti-bird strike protection net for aircraft jet engine as described in claim 1, wherein: The double helix electrical heating wire 14 is used as a deicing device which is covered by an insulating layer and spirally surrounds the outside of the conical protection net body, it commences near the hinge 5 and ends near the summit of the conical support frame 13.

9. An anti-bird strike protection net for aircraft jet engine as described in claim 1, wherein: The conical protection net body may be in shape of the cone, the elliptical cone, the combination of the truncated elliptical cone and the cone, the combination of the truncated cone and the elliptical cone, the combination of the truncated cone and the cone.

10. An anti-bird strike protection net for aircraft jet engine as described in claim 1, wherein: To align with different cowl inlet 2 shapes of jet engines 1 of military or other purpose aircraft, the cowl inlet 2 shapes of the jet engines 1 may vary from round to ellipse, semi-circle, and rectangle, and the shapes of the fixed circular truncated cone 3 and the base of the protection net body 4 should be changed accordingly.

11. An anti-bird strike protection net for aircraft jet engine as described in claim 1, wherein: The present invention is an aftermarket add-on device and it can be an original integration part as jet engine manufacturing.
